(19) United States
(12) Patent Application Publication
(10) Pub. No.: US 2026/0287838 A1
(43) Pub. Date: Sep. 24, 2026

(54) HEATSINK CAP ASSEMBLY FOR A COHERENT PLUG IN AN AIR-COOLED NETWORK SYSTEM

(71) Applicant: Ciena Corporation, Hanover, MD (US)

(72) Inventors: Rampratap Mahawar, Gurugram (IN); Shubham Kumar, Gurugram (IN); Chander Prakash Gupta, Gurugram (IN); Prem Singh, Distt-Etah (IN); Krishan Kant Verma, Gurgaon (IN)

(21) Appl. No.: 19/194,209

(22) Filed: Apr. 30, 2025

(30) Foreign Application Priority Data
Mar. 18, 2025 (IN) 202541024152

(51) Int. Cl. G02B 6/42

(52) U.S. Cl. CPC G02B 6/4269; G02B 6/4236

(57) ABSTRACT

A heatsink cap assembly for a plug, the heatsink cap assembly including a heatsink adapted to be disposed adjacent to and in thermal communication with a laser section or transmit-receive optical sub-assembly (TROSA) heatsink of the plug and an elastic strap structure coupled to the heatsink and adapted to be removably disposed around a laser section or TROSA of the plug. The elastic strap structure is adapted to bias the heatsink into the laser section or TROSA heatsink of the plug. The heatsink and the elastic strap structure are adapted to be slid around the laser section or TROSA heatsink and the laser section or TROSA of the plug external to a module housing of a module with which the plug is engaged.

### CROSS-REFERENCE TO RELATED APPLICATION

The present disclosure claims the benefit of priority of co-pending Indian Patent Application No. 202541024152, filed on Mar. 18, 2025, the contents of which are incorporated in full by reference.

### TECHNICAL FIELD

The present disclosure relates generally to the telecommunications and networking fields. More particularly, the present disclosure relates to a heatsink cap assembly for the laser section or transmit-receive optical sub-assembly (TROSA) of a coherent plug in an air-cooled network system.

### BACKGROUND

Network systems may utilize coherent plugs that have a front side laser section or TROSA, including more recent bidirectional (BiDi) coherent plugs that allow optical data to be transmitted and received over a single optical fiber. Such BiDi coherent plugs are sometimes preferred by network and datacenter customers as they reduce the number of optical fibers required in the field. A smaller optical fiber bundle in the field leads to lower costs for customers who are leasing field optical fibers from a third party, for example.

Most coherent plugs consume <4 W of TROSA power, and the rest of the power (>15 W) is consumed by the back side electronics, which do not directly support the BiDi functionality. To support the BiDi functionality, the front side laser section or TROSA needs extra power of around 10 W for the total 20-25 W optics. These coherent plugs typically utilize an integral or attached laser section or TROSA heatsink that is often not sufficient to cool the coherent plug in an air-cooled network system, especially the 10 W of power of the front side laser section or TROSA for the total 20-25 W optics. Increasing the integral or attached laser section or TROSA heatsink size or height is generally not an available option due to the applicable multi-source agreement (MSA) standards and associated form factor limitations. The result may be insufficient cooling for the front side laser section or TROSA of the coherent plugs, such as the BiDi coherent plugs, that may be expected to operate in a range of −40-65 degrees C., for example.

The present background is provided as illustrative environmental context only and should not be construed to be limiting in any manner. It will be readily apparent to those of ordinary skill in the art that the concepts and principles of the present disclosure may be implemented in other applications and environmental contexts equally, without limitation.

### BRIEF SUMMARY

The present disclosure provides a heatsink cap assembly that may be attached to and detached from the existing integral or attached laser section or TROSA heatsink of a coherent plug to provide enhanced front side laser section or TROSA cooling in an air-cooled network system. This is especially advantageous for a BiDi coherent plug with a front side laser section or TROSA that needs extra power of around 10 W for the total 20-25 W optics.

The heatsink cap assembly includes a heatsink with fins that are thermally coupled to the fins of the existing integral or attached laser section or TROSA heatsink of the coherent plug, optionally utilizing a thermal interface material (TIM). The heatsink cap assembly is thermally coupled to the integral or attached laser section or TROSA heatsink via an elastic strap structure that is disposed around the front section and the integral or attached laser section or TROSA heatsink of the coherent plug, providing thermal contact pressure between the heatsink of the heatsink cap assembly and the integral or attached laser section or TROSA heatsink of the coherent plug through the TIM. This elastic strap structure allows the heatsink cap assembly to be translated onto and translated off of the front section of the coherent plug, even when the coherent plug is disposed in the faceplate of an associated module, as the front section of the coherent plug protrudes from the faceplate of the module.

In some embodiments, the present disclosure provides a heatsink cap assembly for a plug, the heatsink cap assembly including a heatsink adapted to be disposed adjacent to and in thermal communication with a laser section or transmit-receive optical sub-assembly (TROSA) heatsink of the plug and an elastic strap structure coupled to the heatsink and adapted to be removably disposed around a laser section or TROSA of the plug. The elastic strap structure is adapted to bias the heatsink into the laser section or TROSA heatsink of the plug. The heatsink and the elastic strap structure are adapted to be slid around the laser section or TROSA heatsink and the laser section or TROSA of the plug external to a module housing of a module with which the plug is engaged. The heatsink includes a heatsink base adapted to be disposed adjacent to and in thermal communication with a cover surface of the laser section or TROSA heatsink of the plug. The heatsink further includes a plurality of heatsink fins extending from the heatsink base opposite the laser section or TROSA heatsink of the plug. In some embodiments, the elastic strap structure includes a pair of elastic strap structure arms that are adapted to couple the elastic strap structure to the heatsink. In some embodiments, the heatsink cap assembly further includes a thermal interface material (TIM) disposed between the heatsink and the laser section or TROSA heatsink of the plug.

In some embodiments, the present disclosure provides a plug for a network system, the plug including a laser section or transmit-receive optical sub-assembly (TROSA), a laser section or TROSA heatsink, and a heatsink cap assembly including a heatsink adapted to be disposed adjacent to and in thermal communication with the laser section or TROSA heatsink and an elastic strap structure coupled to the heatsink and adapted to be removably disposed around the laser section or TROSA. The elastic strap structure of the heatsink cap assembly is adapted to bias the heatsink of the heatsink cap assembly into the laser section or TROSA heatsink. The heatsink of the heatsink cap assembly and the elastic strap structure of the heatsink cap assembly are adapted to be slid around the laser section or TROSA heatsink and the laser section or TROSA external to a module housing of a module with which the plug is engaged. The heatsink of the heatsink cap assembly includes a heatsink base adapted to be disposed adjacent to and in thermal communication with a cover surface of the laser section or TROSA heatsink. The heatsink of the heatsink cap assembly further includes a plurality of heatsink fins extending from the heatsink base opposite the laser section or TROSA heatsink. In some embodiments, the elastic strap structure of the heatsink cap assembly includes a pair of elastic strap structure arms that are adapted to couple the elastic strap structure to the heatsink of the heatsink cap assembly. In some embodiments, the plug further includes a thermal interface material (TIM) disposed between the heatsink of the heatsink cap assembly and the laser section or TROSA heatsink. In some embodiments, the plug is a bidirectional (BiDi) coherent plug.

In some embodiments, the present disclosure provides a network system plug cooling method including providing a heatsink cap assembly including a heatsink and an elastic strap structure coupled to the heatsink, expanding the elastic strap structure of the heatsink cap assembly, translating the expanded elastic strap structure of the heatsink cap assembly onto a laser section or transmit-receive optical sub-assembly (TROSA) of a plug with the heatsink of the heatsink cap assembly disposed adjacent to a laser section or TROSA heatsink of the plug, and allowing the elastic strap structure of the heatsink cap assembly to contract to bias the heatsink of the heatsink cap assembly into thermal contact with the laser section or TROSA heatsink of the plug. The network system plug cooling method further includes engaging the plug into a module housing of a module with the laser section or TROSA and the laser section or TROSA heatsink of the plug and the heatsink cap assembly external to the module housing of the module. The network system plug cooling method further includes providing a cooling airflow across the heatsink of the heatsink cap assembly and the laser section or TROSA heatsink of the plug and into or out of the module housing of the module. A configuration and material of the elastic strap structure of the heatsink cap assembly are selected to control a thermal contact force between the heatsink of the heatsink cap assembly and the laser section or TROSA heatsink of the plug. In some embodiments, the network system plug cooling method further includes providing a thermal interface material (TIM) disposed between the heatsink of the heatsink cap assembly and the laser section or TROSA heatsink of the plug.

It will be readily apparent to those of ordinary skill in the art that aspects and features of the described embodiments of the present disclosure may be included, omitted, and/or combined as desired in a given application, without limitation.

### BRIEF DESCRIPTION OF THE DRAWINGS

The present disclosure is illustrated and described with reference to the various drawings, in which like reference numbers are used to denote like assembly/system components and/or method steps, as appropriate.

FIG. 1 is a schematic diagram illustrating an embodiment of an air-cooled network system including a coherent plug with a front side laser section or TROSA and an integral or attached laser section or TROSA heatsink.

FIG. 2 is a schematic diagram illustrating an embodiment of an air-cooled network system including a coherent plug with a front side laser section or TROSA, an integral or attached laser section or TROSA heatsink, and the coherent plug front side heatsink cap assembly of the present disclosure.

FIG. 3 illustrates an embodiment of the coherent plug front section heatsink cap assembly of the present disclosure being translated onto and disposed in place on the front side laser section or TROSA of a coherent plug.

FIG. 4 is a series of perspective views (assembled and disassembled) illustrating an embodiment of the coherent plug front section heatsink cap assembly of the present disclosure.

FIG. 5 is a perspective view (disassembled) illustrating an embodiment of the coherent plug front section heatsink cap assembly of the present disclosure.

FIG. 6 illustrates an embodiment of the coherent plug front section heatsink cap assembly of the present disclosure disposed in place on the front side laser section or TROSA of a coherent plug.

FIG. 7 illustrates an embodiment of an air-cooled network system including BiDi coherent plugs each with a front side laser section or TROSA, an integral or attached laser section or TROSA heatsink, and the coherent plug front section heatsink cap assembly of the present disclosure.

FIG. 8 is a flowchart of an embodiment of an air-cooled network system coherent plug cooling method of the present disclosure.

It will be readily apparent to those of ordinary skill in the art that aspects and features of the illustrated embodiments of the present disclosure may be included, omitted, and/or combined as desired in a given application, without limitation.

### DETAILED DESCRIPTION

Again, the present disclosure provides a heatsink cap assembly that may be attached to and detached from the existing integral or attached laser section or TROSA heatsink of a coherent plug to provide enhanced front side laser section or TROSA cooling in an air-cooled network system. This is especially advantageous for a BiDi coherent plug with a front side laser section or TROSA that needs extra power of around 10 W for the total 20-25 W optics.

The heatsink cap assembly includes a heatsink with fins that are thermally coupled to the fins of the integral or attached laser section or TROSA heatsink of the coherent plug, optionally utilizing a thermal interface material (TIM). The heatsink cap assembly is thermally coupled to the existing integral or attached laser section or TROSA heatsink via an elastic strap structure that is disposed around the front section and the integral or attached laser section or TROSA heatsink of the coherent plug, providing thermal contact pressure between the heatsink of the heatsink cap assembly and the integral or attached laser section or TROSA heatsink of the coherent plug through the TIM. This elastic strap structure allows the heatsink cap assembly to be translated onto and translated off of the front section of the coherent plug, even when the coherent plug is disposed in the faceplate of an associated module, as the front section of the coherent plug protrudes from the faceplate of the module.

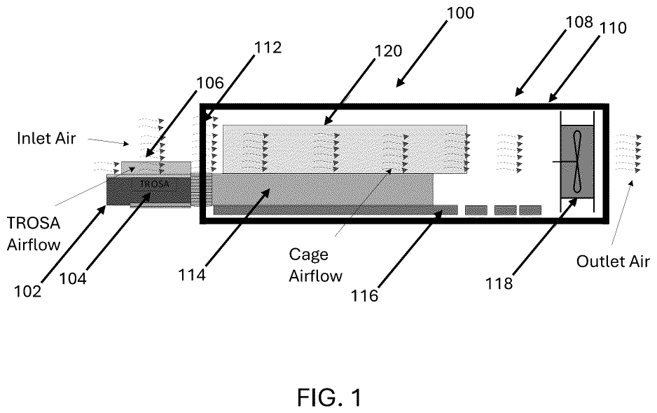

FIG. 1 is a schematic diagram illustrating an embodiment of an air-cooled network system 100 including a coherent plug 102 with a front side laser section or TROSA 104 and an integral or attached laser section or TROSA heatsink 106. The network system 100 includes a module 108 including a module housing 110 and a faceplate 112. A cage 114 in which the coherent plug 102 is disposed is coupled to a printed circuit board (PCB) 116 within the module housing 110. The front side laser section or TROSA 104 is located in the front section of the coherent plug 102 external to the module housing 110. A cooling airflow is drawn through the faceplate 112 of the module 108 and into the interior of the module housing 110 via a fan assembly 118 disposed within the module housing 110. The cooling airflow is drawn through the integral or attached laser section or TROSA heatsink 106 located at the front section of the coherent plug 102, as well as a cage heatsink 120 integrated into or coupled to the cage 114 within the module housing 110.

In this configuration, insufficient cooling airflow (adequate for 4 W of TROSA power, for example) may be provided to the integral or attached laser section or TROSA heatsink 106 and the front side laser section or TROSA 104, especially in a BiDi coherent plug that needs extra power of around 10 W for the front side laser section or TROSA 104 for the total 20-25 W optics. It is desirable that cooling be provided for up to 60 degrees C., or even 85 degrees C., ambient temperature.

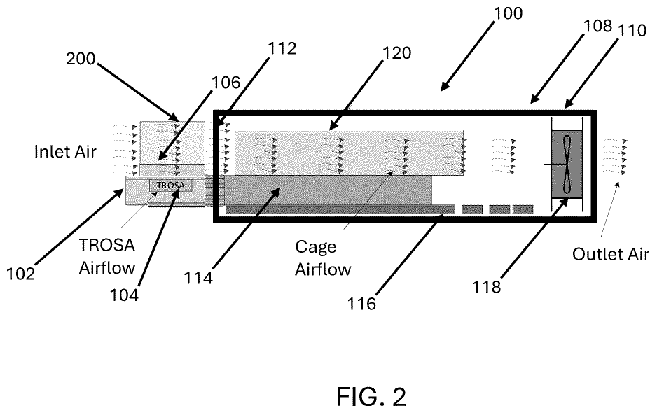

FIG. 2 is a schematic diagram illustrating an embodiment of an air-cooled network system 100 including a coherent plug 102 with a front side laser section or TROSA 104, an integral or attached laser section or TROSA heatsink 106, and the coherent plug front section heatsink cap assembly 200 of the present disclosure. The network system 100 again includes a module 108 including a module housing 110 and a faceplate 112. A cage 114 in which the coherent plug 102 is disposed is coupled to a PCB 116 within the module housing 110. The front side laser section or TROSA 104 is located in the front section of the coherent plug 102 external to the module housing 110. A cooling airflow is again drawn through the faceplate 112 of the module 108 and into the interior of the module housing 110 via a fan assembly 118 disposed within the module housing 110. The cooling airflow is drawn through the integral or attached laser section or TROSA heatsink 106 located at the front section of the coherent plug 102, as well as a cage heatsink 120 integrated into or coupled to the cage 114 within the module housing 110.

The coherent plug front section heatsink cap assembly 200 is in thermal contact with the existing integral or attached laser section or TROSA heatsink 106 of the coherent plug 102 external to the faceplate 112 of the module 108, as is described in greater detail below.

In this configuration, sufficient cooling airflow is provided to the integral or attached laser section or TROSA heatsink 106 and the front side laser section or TROSA 104, especially in a BiDi coherent plug that needs extra power of around 10 W for the front side laser section or TROSA 104 for the total 20-25 W optics. Cooling is provided for up to 60 degrees C., or even 85 degrees C., ambient temperature.

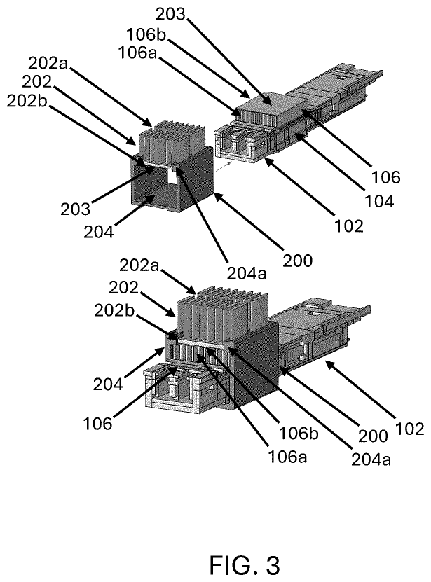

FIG. 3 illustrates an embodiment of the coherent plug front section heatsink cap assembly 200 of the present disclosure being translated onto and disposed in place on the front side laser section or TROSA 104 of a coherent plug 102. The integral or attached laser section or TROSA heatsink 106 of the coherent plug 102 includes a plurality of heatsink fins 106a and a cover surface 106b that encloses the heatsink fins 106a. These components are typically manufactured from a thermally conductive metallic material or the like. The coherent plug front section heatsink cap assembly 200 includes a heatsink 202 including a plurality of heatsink fins 202a and a heatsink base 202b that thermally contacts the cover surface 106b of the integral or attached laser section or TROSA heatsink 106 when the coherent plug front section heatsink cap assembly 200 is translated onto the front section of the coherent plug 102. The heatsink fins 202a and heatsink base 202b are also typically manufactured from a thermally conductive metallic material or the like. The heatsink fins 202a may be arranged in a single row, multiple rows, or any other configuration desired in a given application and may have any desired height desired in the given application. Thus, the heatsink fins 202a include any protrusions from the heatsink base 202b that extend into the surrounding airflow to create enhanced heat transfer area. The heatsink fins 202a serve to extend the heatsink fins 106a (in height and in cooling airflow exposure surface area) that are otherwise limited by MSA constraints, thereby extending the air-cooling capability available to the front side laser section or TROSA 104 external to the faceplate 112 of the module housing 110. A TIM 203 may be disposed between the cover surface 106b of the integral or attached laser section or TROSA heatsink 106 and the heatsink base 202b of the coherent plug front section heatsink cap assembly 200, with the TIM 203 disposed on either or both of the cover surface 106b of the integral or attached laser section or TROSA heatsink 106 and the heatsink base 202b of the coherent plug front section heatsink cap assembly 200.

The coherent plug front section heatsink cap assembly 200 also includes an elastic strap structure 204 coupled to the heatsink 202 that is disposed or stretched around the front section of the coherent plug 102 and the associated integral or attached laser section or TROSA heatsink 106, without the use of screws, clips, or other securement means. The elastic strap structure 204 serves to compress the heatsink base 202b of the coherent plug front section heatsink cap assembly 200 against the cover surface 106b of the integral or attached laser section or TROSA heatsink 106, ensuring good thermal contact between these components. The elastic strap structure 204 may be coupled to the heatsink 202 via a plurality of elastic strap structure arms 204a that engage the heatsink base 202b, conforming to the placement and shape of the heatsink fins 202a. The shape, thickness, and material (rubber, plastic, elastomer, etc.) of the elastic strap structure 204 may be varied to control the degree of thermal compression of the heatsink 202 of the coherent plug front section heatsink cap assembly 200 onto the integral or attached laser section or TROSA heatsink 106 of the coherent plug 102. For example, the elastic strap structure 204 may include slots or internal openings that increase its elasticity and decrease it compressive force. All or a portion of the elastic strap structure 204 may be manufactured from the deformable but resilient material, while a portion of the elastic strap structure 204 may be substantially rigid and manufactured from a different material.

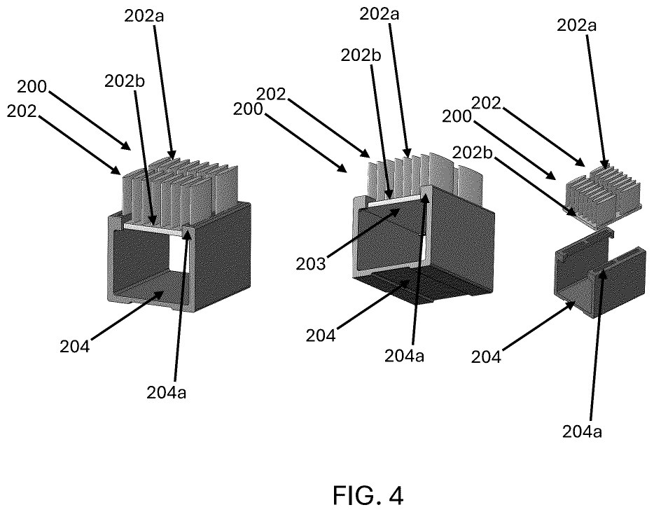

FIG. 4 is a series of perspective views (assembled and disassembled) illustrating an embodiment of the coherent plug front section heatsink cap assembly 200 of the present disclosure. Again, the coherent plug front section heatsink cap assembly 200 includes the heatsink 202 including the plurality heatsink fins 202a and the heatsink base 202b that thermally contacts the cover surface 106b of the integral or attached laser section or TROSA heatsink 106 when the coherent plug front section heatsink cap assembly 200 is translated onto the front section of the coherent plug 102. The heatsink fins 202a may be arranged in a single row, multiple rows, or any other configuration desired in a given application and may have any desired height desired in the given application. The heatsink fins 202a serve to extend the heatsink fins 106a (in height and in cooling airflow exposure surface area) that are otherwise limited by MSA constraints, thereby extending the air-cooling capability available to the front side laser section or TROSA 104. The TIM 203 may be disposed between the cover surface 106b of the integral or attached laser section or TROSA heatsink 106 and the heatsink base 202b of the coherent plug front section heatsink cap assembly 200, with the TIM 203 disposed on either or both of the cover surface 106b of the integral or attached laser section or TROSA heatsink 106 and the heatsink base 202b of the coherent plug front section heatsink cap assembly 200.

The coherent plug front section heatsink cap assembly 200 also includes the elastic strap structure 204 coupled to the heatsink 202 that is disposed or stretched around the front section of the coherent plug 102 and the integral or attached laser section or TROSA heatsink 106. The elastic strap structure 204 serves to compress the heatsink base 202b of the coherent plug front section heatsink cap assembly 200 against the cover surface 106b of the integral or attached laser section or TROSA heatsink 106, ensuring good thermal contact. Again, the elastic strap structure 204 may be coupled to the heatsink 202 via a plurality of elastic strap structure arms 204a that engage the heatsink base 202b, conforming to the placement and shape of the heatsink fins 202a. The shape, thickness, and material (rubber, plastic, elastomer, etc.) of the elastic strap structure 204 may be varied to control the degree of thermal compression of the heatsink 202 of the coherent plug front section heatsink cap assembly 200 onto the integral or attached laser section or TROSA heatsink 106. All or a portion of the elastic strap structure 204 may be manufactured from the deformable but resilient material, while a portion of the elastic strap structure 204 may be substantially rigid.

The elastic strap structure arms 204a may have sufficient rigidity such that the elastic strap structure arms 204a are capable of grasping and retaining the heatsink base 202b, with or without additional securement mechanisms between the elastic strap structure 204 and the heatsink base 202b. The elastic strap structure arms 204a may also be bonded, adhered, or otherwise secured to the heatsink base 202b, such that the coherent plug front section heatsink cap assembly 200 forms a whole or partial ring structure that is disposed around the front section of the coherent plug 102, including the front side laser section or TROSA 104 and the integral or attached laser section or TROSA heatsink 106.

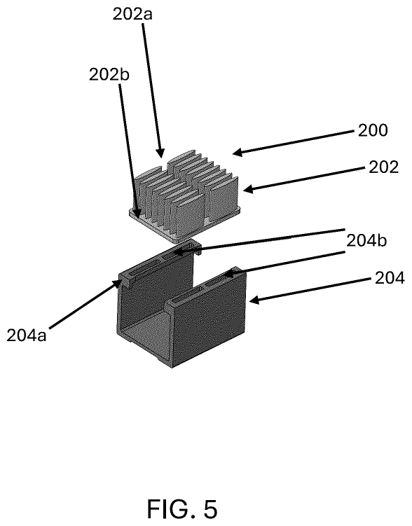

FIG. 5 is a perspective view (disassembled) illustrating an embodiment of the coherent plug front section heatsink cap assembly 200 of the present disclosure. Again, the coherent plug front section heatsink cap assembly 200 includes the heatsink 202 including the plurality heatsink fins 202a and the heatsink base 202b that thermally contacts the cover surface 106b of the integral or attached laser section or TROSA heatsink 106 when the coherent plug front section heatsink cap assembly 200 is translated onto the front section of the coherent plug 102. The heatsink fins 202a may be arranged in a single row, multiple rows, or any other configuration desired in a given application and may have any desired height desired in the given application. The heatsink fins 202a serve to extend the heatsink fins 106a (in height and in cooling airflow exposure surface area) that are otherwise limited by MSA constraints, thereby extending the air-cooling capability available to the front side laser section or TROSA 104. The TIM 203 may be disposed between the cover surface 106b of the integral or attached laser section or TROSA heatsink 106 and the heatsink base 202b of the coherent plug front section heatsink cap assembly 200, with the TIM 203 disposed on either or both of the cover surface 106b of the integral or attached laser section or TROSA heatsink 106 and the heatsink base 202b of the coherent plug front section heatsink cap assembly 200.

The coherent plug front section heatsink cap assembly 200 also includes the elastic strap structure 204 coupled to the heatsink 202 that is disposed or stretched around the front section of the coherent plug 102 and the integral or attached laser section or TROSA heatsink 106. The elastic strap structure 204 serves to compress the heatsink base 202b of the coherent plug front section heatsink cap assembly 200 against the cover surface 106b of the integral or attached laser section or TROSA heatsink 106, ensuring good thermal contact. Again, the elastic strap structure 204 may be coupled to the heatsink 202 via a plurality of elastic strap structure arms 204a that engage the heatsink base 202b, conforming to the placement and shape of the heatsink fins 202a. The shape, thickness, and material (rubber, plastic, elastomer, etc.) of the elastic strap structure 204 may be varied to control the degree of thermal compression of the heatsink 202 of the coherent plug front section heatsink cap assembly 200 onto the integral or attached laser section or TROSA heatsink 106. All or a portion of the elastic strap structure 204 may be manufactured from the deformable but resilient material, while a portion of the elastic strap structure 204 may be substantially rigid.

As illustrated, the elastic strap structure arms 204a may have sufficient rigidity such that the elastic strap structure arms 204a are capable of grasping and retaining the heatsink base 202b, with or without additional securement mechanisms between the elastic strap structure 204 and the heatsink base 202b. Further, cutouts 204b are provided in the elastic strap structure arms 204a to accommodate and conform to the heatsink fins 202a. In an example, the cutouts 204b may be oval. However, other shapes are also possible without limitation. The elastic strap structure 204 and metal heatsink 202 may be joined together with the oval cutouts on the elastic strap structure arms 204a.

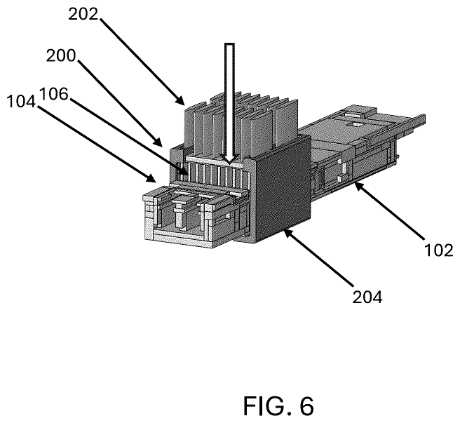

FIG. 6 illustrates an embodiment of the coherent plug front section heatsink cap assembly 200 of the present disclosure disposed in place on the front side laser section or TROSA 104 and the integral or attached laser section or TROSA heatsink 106 of a coherent plug 102. The elasticity of the elastic strap structure 204 serves to bias the heatsink 202 against the integral or attached laser section or TROSA heatsink 106, ensuring good thermal contact between the heatsinks 202 and 106, while allowing the coherent plug front section heatsink cap assembly 200 to be placed and removed via translation when desired.

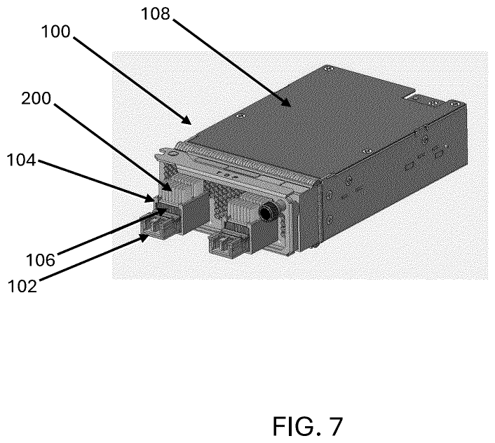

FIG. 7 illustrates an embodiment of an air-cooled network system 100 utilizing a module 108 including BiDi coherent plugs 102 each with a front side laser section or TROSA 104, an integral or attached laser section or TROSA heatsink 106, and the coherent plug front section heatsink cap assembly 200 of the present disclosure.

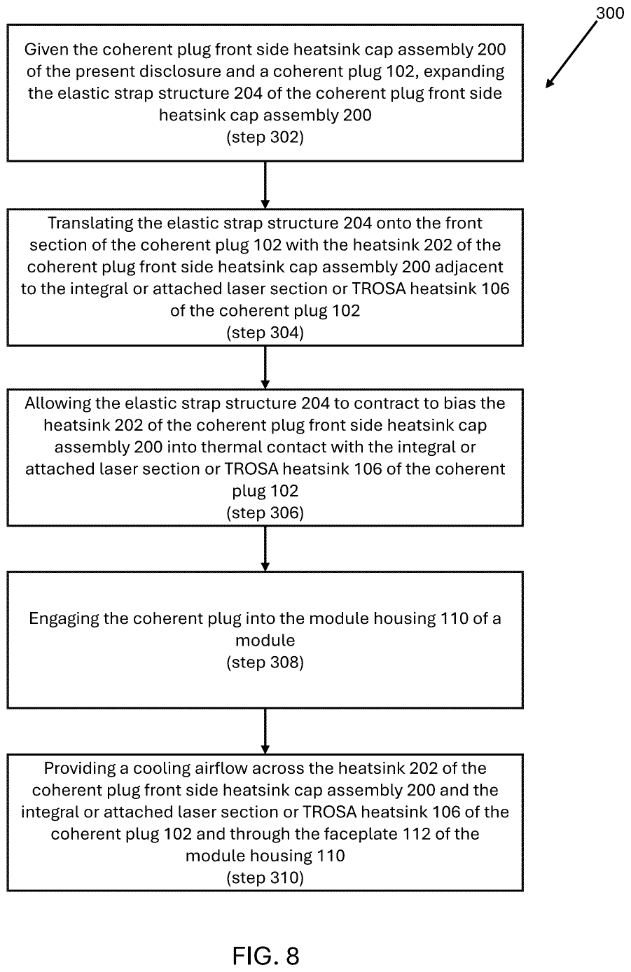

FIG. 8 is a flowchart of an embodiment of an air-cooled network system coherent plug cooling method 300 of the present disclosure. The method 300 includes, given the coherent plug front section heatsink cap assembly 200 of the present disclosure and a coherent plug 102, expanding the elastic strap structure 204 of the coherent plug front section heatsink cap assembly 200 (step 302) and translating the elastic strap structure 204 onto the front section of the coherent plug 102 with the heatsink 202 of the coherent plug front section heatsink cap assembly 200 adjacent to the integral or attached laser section or TROSA heatsink 106 of the coherent plug 102 (step 304). Further, the method 300 includes allowing the elastic strap structure 204 to contract to bias the heatsink 202 of the coherent plug front section heatsink cap assembly 200 into thermal contact with the integral or attached laser section or TROSA heatsink 106 of the coherent plug 102 (step 306). Further, the method 300 includes engaging the coherent plug into the module housing 110 of a module (step 308) and providing a cooling airflow across the heatsink 202 of the coherent plug front section heatsink cap assembly 200 and the integral or attached laser section or TROSA heatsink 106 of the coherent plug 102 and through the faceplate 112 of the module housing 110 (step 310). The coherent plug front section heatsink cap assembly 200 is removed from the coherent plug by reversing the applicable steps.

The systems and methods of the present disclosure may provide an air-cooling improvement of approximately 8-10 degrees C. in TROSA temperature with a TROSA consuming 10 W, for example. Further, the heatsink fins can be customized if more temperature improvement is required. Advantageously, the heatsink cap assembly of the present disclosure is readily attachable/detachable at the front faceplate of a network module and usable for a high-power TROSA (>10 W) for a BiDi coherent plug or the like. The slip-on elastic rubber attachment to put pressure on the heatsink has not been used previously, especially not without the use of other additional securement means.

Although the present disclosure is illustrated and described with reference to specific embodiments and examples, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes, without limitation.

What is claimed is:

1. A heatsink cap assembly for a plug, the heatsink cap assembly comprising
a heatsink adapted to be disposed adjacent to and in thermal communication with a laser section or transmit-receive optical sub-assembly (TROSA) heatsink of the plug, and
an elastic strap structure coupled to the heatsink and adapted to be removably disposed around a laser section or TROSA of the plug.

2. The heatsink cap assembly of claim 1, wherein the elastic strap structure is adapted to bias the heatsink into the laser section or TROSA heatsink of the plug.

3. The heatsink cap assembly of claim 1, wherein the heatsink and the elastic strap structure are adapted to be slid around the laser section or TROSA heatsink and the laser section or TROSA of the plug external to a module housing of a module with which the plug is engaged.

4. The heatsink cap assembly of claim 1, wherein the heatsink comprises a heatsink base adapted to be disposed adjacent to and in thermal communication with a cover surface of the laser section or TROSA heatsink of the plug.

5. The heatsink cap assembly of claim 4, wherein the heatsink further comprises a plurality of heatsink fins extending from the heatsink base opposite the laser section or TROSA heatsink of the plug.

6. The heatsink cap assembly of claim 1, wherein the elastic strap structure comprises a pair of elastic strap structure arms that are adapted to couple the elastic strap structure to the heatsink.

7. The heatsink cap assembly of claim 1, further comprising a thermal interface material (TIM) disposed between the heatsink and the laser section or TROSA heatsink of the plug.

8. A plug for a network system, the plug comprising
a laser section or transmit-receive optical sub-assembly (TROSA),
a laser section or TROSA heatsink, and
a heatsink cap assembly comprising
a heatsink adapted to be disposed adjacent to and in thermal communication with the laser section or TROSA heatsink, and
an elastic strap structure coupled to the heatsink and adapted to be removably disposed around the laser section or TROSA.

9. The plug of claim 8, wherein the elastic strap structure of the heatsink cap assembly is adapted to bias the heatsink of the heatsink cap assembly into the laser section or TROSA heatsink.

10. The plug of claim 8, wherein the heatsink of the heatsink cap assembly and the elastic strap structure of the heatsink cap assembly are adapted to be slid around the laser section or TROSA heatsink and the laser section or TROSA external to a module housing of a module with which the plug is engaged.

11. The plug of claim 8, wherein the heatsink of the heatsink cap assembly comprises a heatsink base adapted to be disposed adjacent to and in thermal communication with a cover surface of the laser section or TROSA heatsink.

12. The plug of claim 11, wherein the heatsink of the heatsink cap assembly further comprises a plurality of heatsink fins extending from the heatsink base opposite the laser section or TROSA heatsink.

13. The plug of claim 8, wherein the elastic strap structure of the heatsink cap assembly comprises a pair of elastic strap structure arms that are adapted to couple the elastic strap structure to the heatsink of the heatsink cap assembly.

14. The plug of claim 8, further comprising a thermal interface material (TIM) disposed between the heatsink of the heatsink cap assembly and the laser section or TROSA heatsink.

15. The plug of claim 8, wherein the plug is a bidirectional (BiDi) coherent plug.

16. A network system plug cooling method, comprising
providing a heatsink cap assembly comprising a heatsink and an elastic strap structure coupled to the heatsink,
expanding the elastic strap structure of the heatsink cap assembly,
translating the expanded elastic strap structure of the heatsink cap assembly onto a laser section or transmit-receive optical sub-assembly (TROSA) of a plug with the heatsink of the heatsink cap assembly disposed adjacent to a laser section or TROSA heatsink of the plug, and
allowing the elastic strap structure of the heatsink cap assembly to contract to bias the heatsink of the heatsink cap assembly into thermal contact with the laser section or TROSA heatsink of the plug.

17. The network system plug cooling method of claim 16, further comprising engaging the plug into a module housing of a module with the laser section or TROSA and the laser section or TROSA heatsink of the plug and the heatsink cap assembly external to the module housing of the module.

18. The network system plug cooling method of claim 17, further comprising providing a cooling airflow across the heatsink of the heatsink cap assembly and the laser section or TROSA heatsink of the plug and into or out of the module housing of the module.

19. The network system plug cooling method of claim 16, wherein a configuration and material of the elastic strap structure of the heatsink cap assembly are selected to control a thermal contact force between the heatsink of the heatsink cap assembly and the laser section or TROSA heatsink of the plug.

20. The network system plug cooling method of claim 16, further comprising providing a thermal interface material (TIM) disposed between the heatsink of the heatsink cap assembly and the laser section or TROSA heatsink of the plug.
